(19) United States
(12) Patent Application Publication
(10) Pub. No.: US 2013/0325302 A1
(43) Pub. Date: Dec. 5, 2013

(54) METHOD FOR KNOCK DETECTION

(71) Applicant: BorgWarner BERU Systems GmbH, (US)

(72) Inventors: Martin Trump, Stuttgart (DE); Steffen Bohne, Freiburg (DE)

(21) Appl. No.: 13/891,616

(22) Filed: May 10, 2013

(30) Foreign Application Priority Data
May 30, 2012 (DE) 10 2012 104 654.9

(51) Int. Cl. F02D 45/00

(52) U.S. Cl. CPC F02D 45/00
USPC 701/111

(57) ABSTRACT

A method for knock detection in an internal combustion engine in which a fuel/air mixture is ignited by means of a corona discharge. To generate the corona discharge, an electrical resonant circuit is excited, in which an ignition electrode that is electrically insulated with respect to combustion chamber walls constitutes a capacitor together with the combustion chamber walls. For knock detection, an electrical variable of the resonant circuit is measured and the course thereof is evaluated. The course of the electrical variable is checked to determine whether it has a local extremum after the start of the fuel combustion.

### CROSS REFERENCE TO RELATED APPLICATIONS

This application claims priority to DE 10 2012 104 654.9 filed on May 30, 2012 entitled METHOD FOR KNOCK DETECTION, the disclosure of which is hereby incorporated herein by reference.

### BACKGROUND

The invention relates to a method for knock detection in an internal combustion engine in which a fuel/air mixture is ignited by a corona discharge. One example of a known method is described in DE 10 2009 013 877 A1.

Ignition devices with which a fuel/air mixture is ignited by a corona discharge contain an electrical resonant circuit, in which an ignition electrode that is electrically insulated with respect to combustion chamber walls constitutes a capacitor together with the combustion chamber walls. By exciting the resonant circuit, a corona discharge can be generated at the ignition electrode and thereby ignite the fuel/air mixture contained in the combustion chamber. Such a corona ignition device is described for example in WO 2010/011838. The content of the combustion chamber is the dielectric of the capacitor formed by the ignition electrode and the combustion chamber walls. As disclosed herein, electrical variables of the resonant circuit of a corona ignition device are therefore particularly suitable for obtaining information regarding the combustion chamber and a fuel combustion process taking place therein.

### SUMMARY

The present invention demonstrates a way in which a knocking combustion can be detected.

With a method disclosed herein, it is checked whether the course of an electrical variable of the resonant circuit has a local extremum after the start of the fuel combustion. Within the scope of the invention, it has been recognised that a local extremum after the start of the fuel combustion indicates a knocking combustion. The extremum is a maximum or a minimum depending on which electrical variable is considered.

The electrical variable of the resonant circuit may be, for example, the resonance frequency of the resonant circuit, the impedance of the resonant circuit or the phase position between current and voltage. With frequency-controlled resonant circuits, the resonance frequency can be examined as an electrical variable in a method as described herein, for example, with phase-locked loops. With frequency-controlled resonant circuits, the phase position between current and voltage is a particularly well suited variable.

Whether the course of an electrical variable of the resonant circuit contains a local extremum after the start of the fuel combustion can be determined for example by subjecting a continuously measured measurement signal of the electrical variable to a filtering process, for example high-pass filtering, and by examining the filtered signal for the presence of an extremum. Knocking combustion leads specifically to vibrations of the combustion chamber contents in the acoustic frequency range. These oscillations are then also found in the course of electrical variables of the resonant circuit. Knocking combustion therefore means that the course of the electrical variable of the resonant circuit changes with a frequency of more than one kilohertz, in particular of more than three kilohertz, for example of more than four kilohertz. Since a corresponding threshold value is used for high-pass filtering, the measurement signal of the electrical variable of the resonant circuit can therefore be processed. If an extremum of the electrical variable of the resonant circuit is evident after such a filtering process, this indicates a knocking combustion.

For example, the high-pass filtering can be carried out using a band-pass filter. Frequencies of more than 30 kHz, often even of more than 20 kHz, do not generally need to be taken into consideration for the detection of a knocking combustion. A band-pass filter of which the lower threshold is 4 kHz or below can therefore be used for example. The upper threshold of a band-pass filter may lie anywhere in the range from 20 kHz to 30 kHz.

In order to quantify the extent of the knocking, the extremum found after filtering can be evaluated, for example the difference between the value of the extremum and the value of the electrical variable, some time before or after the extremum. As a characteristic variable of the knocking behaviour, an integral of the measurement signal of the electrical variable can also be calculated for example in a predefined range around the extreme value found after filtering. The breadth of this range can be predefined absolutely as a crankshaft angle interval, but can also be determined for example by a predefined number of milliseconds or by the breadth of a peak associated with the extremum. For example, the limits of the range over which the integral is calculated can be defined to the extent that the variable deviates therein by a predefined factor from the value of the extremum, for example by 50%.

A further possibility for examining whether the course of the electrical variable has an extremum after the start of the fuel combustion lies in establishing whether the course of the electrical variable has more than two local extrema from the formation of the corona discharge. Within the scope of the present disclosure, it was specifically recognised that a further local extremum, in particular after the start of combustion, indicates a knocking combustion. An abnormal ignition in a knock center (detonation), is particularly clearly visible in electrical variables.

When a corona discharge is produced, there is initially a rise in the resonance frequency of the resonant circuit. As a result of the formation of the corona discharge, the resonance frequency then falls, since pre-reactions occur and the ionisation of the fuel/air mixture increases. As soon as the fuel/air mixture ignites, the resonance frequency rises. In a working cycle of a cylinder of an internal combustion engine, a maximum of the resonance frequency of the resonant circuit and then a minimum of the resonance frequency of the ignition circuit are thus determined, even with regularly executed ignition. The course of the impedance of the resonant circuit of a corona discharge device accordingly initially displays a minimum and, at the start of ignition, a maximum.

The corona discharge is generally ignited again in each working cycle of the engine. It is, however, also possible to allow the corona discharge to burn during the entire cycle, that is to say to ignite the corona discharge only when starting the engine.

With ideal fuel combustion, the rise in the resonance frequency is continuous monotonously until the end of the corona discharge. With a knocking combustion, this rise in resonance frequency is interrupted by an explosion-like partial combustion, which leads to a fall in the frequency. Knocking combustion is thus evident since the course of the electrical variable additionally has a third and also a fourth local extremum after the start of the combustion process.

The start of the fuel combustion can be detected at an extremum in the course of the electrical variable, for example the resonance frequency of the resonant circuit, the impedance of the resonant circuit or the phase position between current and voltage. The start of the combustion process is specifically associated with an extremum.

With very slow ignition, for example partial load or late ignition points, it may be that additional extrema occur before the start of the combustion process, but are insignificant for the detection of a knocking combustion. With delayed ignition too, no knocking is to be expected. The extremum associated with the start of the combustion process is generally much more strongly pronounced compared to any additional extrema possibly present and can therefore be easily differentiated from additional extrema, which may occur in the event of delayed ignition as a result of compression of the combustion chamber contents. If the extremum is a maximum, for example of the impedance, the maximum belonging to the start of combustion therefore has a greater value than any maximum occurring previously. If the extremum is a minimum, for example of the resonance frequency, the minimum belonging to the start of combustion therefore has a smaller value than any minimum occurring previously.

The extremum associated with the start of the combustion process is generally also characterised in that it is preceded by a pronounced extremum of the first derivative. The extremum associated with the start of the combustion process is typically preceded by a global extremum of the first derivative. Alternatively or additionally, the extremum that belongs to the start of the combustion process can therefore also be identified by evaluation of the first derivative.

In order to quantise the extent of the knocking combustion, a difference between a third and fourth local extremum or the difference between two extrema after the start of the combustion process can be calculated as a characteristic variable of the knocking behaviour. Alternatively or additionally, the maximum or the minimum of the first time derivative between the third and the fourth extremum or between two extrema that occur after the start of the combustion process can be calculated as a characteristic variable of the knocking behaviour. Corrections are advantageously then made to the calculated characteristic variables of the knocking and are dependent on the operating point of the engine.

### BRIEF DESCRIPTION OF THE DRAWINGS

Further details and advantages of the invention will be explained on the basis of exemplary embodiments with reference to the accompanying drawings, in which:

FIGS. 1a, 1b and 1c show three schematic courses of the resonance frequency of the resonant circuit of a corona discharge device;

FIGS. 2a, 2b and 2c show three schematic courses of the impedance of the resonant circuit of a corona discharge device;

FIG. 3 shows a flow diagram of an embodiment of a method for knock detection; and

FIG. 4 shows a flow diagram of a further method for knock detection.

Corresponding reference characters indicate corresponding parts throughout the several views. Although the exemplification set out herein illustrates embodiments of the invention, the embodiments disclosed below are not intended to be exhaustive or to be construed as limiting the scope of the invention to the precise forms disclosed.

### DETAILED DESCRIPTION

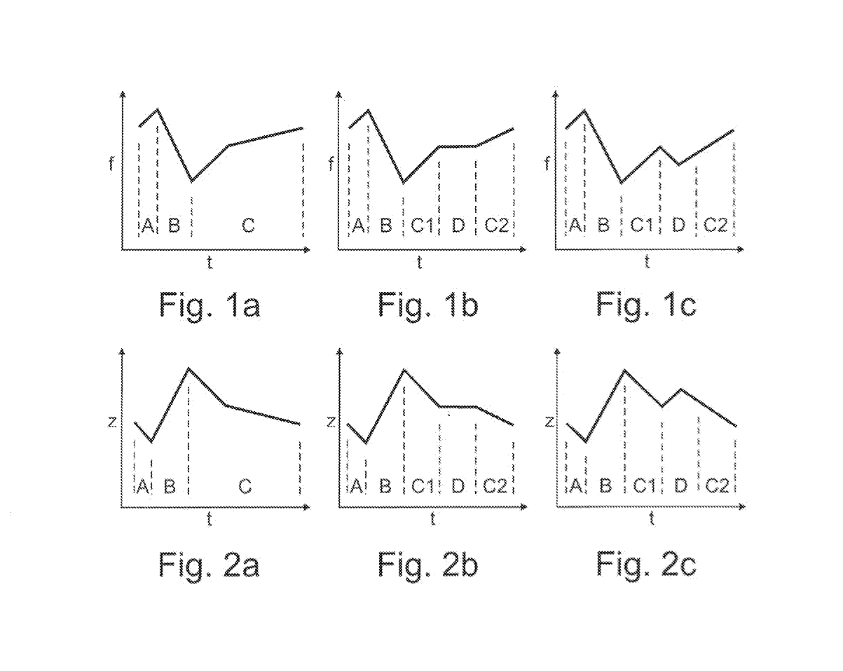

FIG. 1a shows a schematic illustration of the course of the resonance frequency f of the electrical resonant circuit of a corona ignition device with optimal combustion. As can be seen, the resonance frequency f changes significantly over time t and therefore also with the crankshaft angle. The course, starting with a crankshaft angle of approximately 15° before the top dead center to 15° after the top dead center as far as a crankshaft angle of approximately 40° to 50° after the top dead center is illustrated. Depending on the engine operation, ignition point and combustion time of the corona discharge may be slightly different. The abscissa is therefore not provided with units in the schematic illustration presented in the figures.

In region A in FIG. 1a, the transient state of the resonant circuit before the formation of a corona discharge is accompanied by a rise in the resonance frequency. The region A can be referred to as the tuning phase. In a subsequent region B, the resonance frequency then falls. The fall in the resonance frequency in the region B is illustrated in a highly simplified manner in FIG. 1a. In fact, the fall is not linear in the entire region B. When viewed in greater detail, the region B can be divided into a number of sub-regions, in which the frequency falls rapidly to a varying degree. In the region B, the formation of the corona discharge results in increasing ionisation of the fuel/air mixture, pre-reactions, and, at the end of the region B, ultimately the start of the fuel combustion. In the region C, the actual fuel combustion then takes place. At the start, a flame inner core is distanced from the ignition tip and the combustion front then propagates through the entire combustion chamber, as a result of which the direct influence on the resonant circuit decreases and the frequency rises in spite of continued combustion. The region C is characterised by a monotonous rise in the frequency of the resonant circuit.

FIG. 2a shows accordingly how the impedance Z of the resonant circuit of a corona discharge device changes over time t with ideal fuel combustion. A comparison of FIGS. 1a and 2a shows that a minimum of the impedance Z corresponds to a maximum of the resonance frequency f, and a minimum of the resonance frequency corresponds to a maximum of the impedance.

FIG. 1b schematically shows how the resonance frequency f of the electrical resonant circuit of a corona discharge device changes over time t with an abnormal combustion. The regions A and B at most differ insignificantly from the regions A and B in the event of ideal combustion, for which the course of the resonance frequency is sketched in FIG. 1a. After the local minimum of the resonance frequency, there is initially a rise in the resonance frequency in a region C1. The resonance frequency then stagnates in a region D. Only at the end of the region D is there a further rise in the resonance frequency. FIG. 2b accordingly shows the development of the impedance during such a combustion process. After the maximum of the impedance, there is initially a fall over the region C1. The impedance then stagnates in the region D.

FIG. 2b accordingly shows how the impedance Z of the resonant circuit of a corona discharge device changes over time t in the event of abnormal combustion of this type.

FIG. 1c schematically shows the course of the resonance frequency f of an electrical resonant circuit of a corona discharge device with knocking combustion. In the regions A, B and C1, substantially the same course as with FIG. 1b is shown. Following on from the combustion starting at C1, there is then a temporary fall in the frequency in the region D. This predominant fall in the frequency after the start of the combustion process is characteristic for a knocking combustion.

The course of the resonance frequency f in FIG. 1c therefore has four local extrema. The course illustrated in FIG. 2c of the impedance Z of the electrical resonant circuit of the corona discharge device with knocking combustion accordingly likewise shows four local extrema. The first two extrema at the end of the regions A and B also occur with optimal combustion. The predominant rise in impedance Z in the region D and the associated formation of two further extrema after the start of the combustion process, that is to say in this case of a third and fourth extremum, is characteristic for knocking combustion.

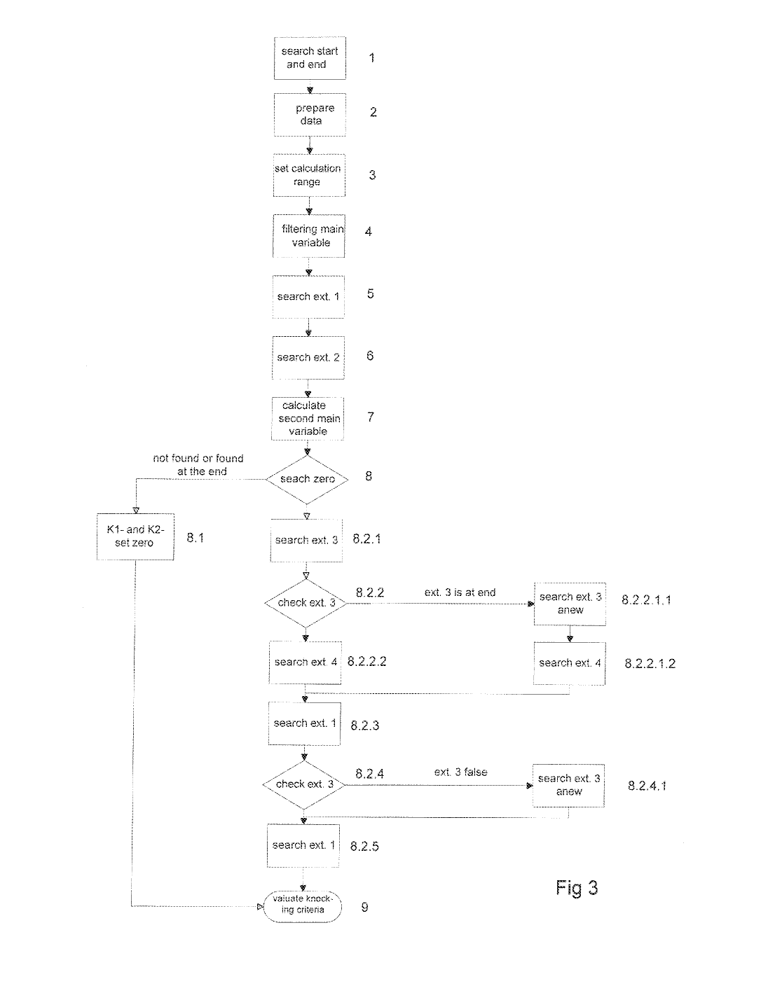

FIG. 3 shows a flow diagram of an embodiment of a method for knock detection in an internal combustion engine in the combustion chamber of which a fuel/air mixture is ignited by a corona discharge.

At the start of the method, the start and end of a relevant time interval in which the occurrence of a knocking combustion is subsequently sought is determined in a step 1. For example, the start of the corona discharge and also the end of the fuel combustion can be established from a voltage signal, a current signal and/or another electrical variable. It is also possible for the start and end of the time interval that is to be examined to be predefined by an engine control unit.

As step 2, raw data can be processed, for example intermediate values of measured values of an electrical variable of the resonant circuit of the corona discharge device can be established by interpolation. In step 2, a measurement signal can be filtered, for example using a low-pass filter. Depending on whether voltage signals and/or current signals are to be transferred as RMS (root mean square) values or as raw data, different threshold values for low-pass filtering are expedient. When transferring RMS values, a threshold frequency from 1 kilohertz to 500 kilohertz may be expedient for example. When transferring high-frequency raw data, low-pass filtering with a threshold value in the region of 1 megahertz to 20 megahertz may be advantageous for example. Characteristic variables of the resonant circuit, such as the resonance frequency or impedance thereof, can be calculated in step 2, for example from voltage raw data and current raw data via zero-point finding or by transformations. It is also possible, however, for such characteristic variables of the resonant circuit to already be present at the start of the method.

In a step 3, a calculation range for the method can be determined. The start of this range for example is the time at which the course of the electrical variable, for example resonance frequency, impedance or phase position between current and voltage, has a first extremum. The disconnection of the corona discharge or a predefined crankshaft angle, for example a crankshaft angle in the range from 40° to 50° after the top dead center, can be used as the end of this range.

In a subsequent step 4, the measured values can be filtered again or for the first time, for example using a low-pass filter. In particular, low-pass filtering processes with threshold values in the range from 1 kilohertz to 500 kilohertz or more are suitable. Disturbing pulses that could otherwise be interpreted incorrectly as extrema can be filtered out by means of such a filtering process.

In a step 5, a first extreme value of the electrical variable is established. If the electrical variable is the resonance frequency of the resonant circuit of the corona discharge device, this first extreme value is a maximum. If the examined electrical variable is the impedance of the resonant circuit of the electrical ignition device, this first extreme value is a minimum. The first extreme value occurs between the regions A and B in FIGS. 1 and 2.

In a subsequent step 6, a second extreme value is sought. The second extremum occurs in the course of the electrical variable after the first extremum and marks the start of the combustion process. If the first extremum is a maximum, the second extremum is a minimum. If the first extremum is a minimum, the second extremum is a maximum. The second extremum is between the regions B and C in the schematic illustrations in FIGS. 1 and 2.

With a delayed start of the combustion process, it may be that a further extremum is present in the region B. More specifically, the region B then contains both a maximum and a minimum, which may be caused by compression of the fuel/air mixture. If a further extremum occurs, this is generally less strongly pronounced than the extremum belonging to the start of the combustion process. It can therefore be detected by a simple magnitude comparison. In addition, a further extremum, which may possibly be present, is also preceded by a less pronounced, that is to say smaller, extremum of the first derivative compared to the extremum that is caused by the start of the combustion process. The extremum belonging to the start of the combustion process can therefore also be identified by evaluation of the first time derivative. Alternatively or in addition, the extremum belonging to the start of the combustion process may also be identified by consideration of the crankshaft angle belonging thereto.

Should a knocking combustion be present, and should therefore two further extrema occur in the course of the electrical variable after the start of the combustion process, that is to say a further maximum and a further minimum, these are often less strongly pronounced than the first and the second extremum. These two further extrema generally occur as third and fourth extrema, although this is not necessarily the case.

In order to identify with greater reliability any possibly present extremum after the start of the combustion process, it is very advantageous to use an auxiliary operand calculated from the electrical variable. This auxiliary operand may be the first time derivative or the difference from a reference course. In a step 7 of the embodiment illustrated, such an operand is calculated. This is referred to in step 7 as a second main variable. It is sufficient to calculate the value of the second main variable, that is to say for example the value of the first time derivative for a range of the signal course of the variable that follows the extremum marking the start of the combustion process.

In a step 8 it is examined whether a zero is located in the course of the second main variable, that is to say for example of the first time derivative. A zero of the first time derivative is specifically a necessary condition for the presence of an extremum. If, in step 8, no zero is found, it can be assumed that no knocking combustion is present. In this case, the two parameters K1 and K2 are each set to 0 in a step 8.1. K1 and K2 are characteristic variables for the knocking behaviour. A value 0 of these characteristic variables indicates that there is no knocking combustion. The greater the value of the characteristic variables K1 and K2, the more intensive is the knocking.

If, in step 8, a zero has been found in the course of the second main variable, it is examined in a step 8.2.1 whether this zero is associated with a third extremum, for example whether an extremum follows this zero. If the extremum lies at the end of the observed course, it is rejected and the search for an extremum is repeated in a step 8.2.1.1, wherein said extremum is then sought before the zero.

A further extremum, typically the fourth extremum, is then sought in step 8.2.2.2 or step 8.2.2.1.2.

To check the results found, an extremum of the second main variable, that is to say for example an extremum of the first time derivative, is sought in a step 8.2.3. This extremum of the second main quantity is preferably sought between the zero of the second main quantity and the next, subsequent extremum. Here, a local extremum of the derivative should be found between adjacent extrema. If this is not the case, the extremum that follows the extremum marking the start of the combustion process is identified as being possibly incorrect and is therefore checked again, for example in a step 8.2.4.1.

In a step 8.2.5, parameters K1 and K2 are then calculated in order to quantify the knocking. For example, a value corresponding to a maximum or minimum value of the first time derivative after the start of the combustion process can be assigned to the parameter K1. For example, the parameter K2 can be calculated as the difference between the two extreme values found after the start of the combustion process, that is to say as the difference between a maximum and minimum occurring after the start of the combustion process. With the course in FIGS. 1c and 2c, this would be the difference between the third and the fourth extremum.

The knock parameters K1 and K2 can then be adapted or corrected under consideration of engine operating parameters. For example, corrections dependent on the operating point of the engine can be made to knock parameters. Corrections of this type can be made in particular using a characteristic map.

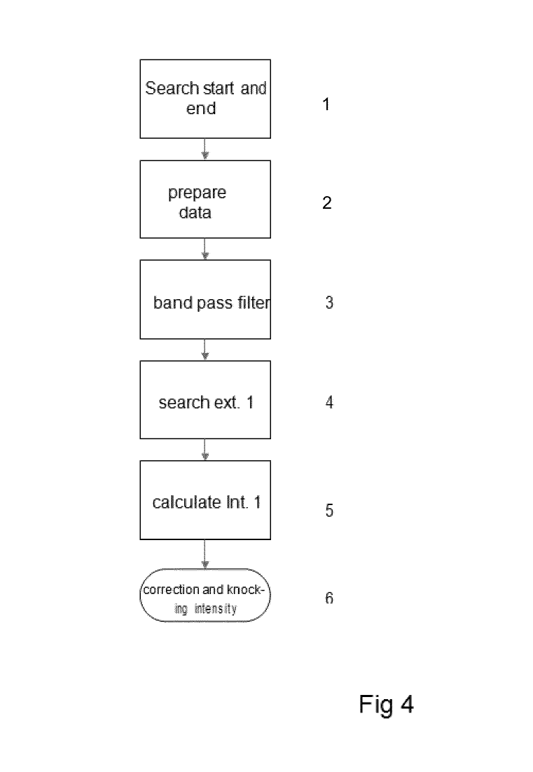

FIG. 4 shows a flow diagram of an embodiment of a further method for knock detection. This method can be carried out alternatively to or in combination with the method described above with reference to FIG. 3.

Step 1 of the method illustrated in FIG. 4 can be carried out identically to step 1 of the method of FIG. 3. The start and end of the ignition process can be determined on the basis of a measurement signal that reflects the state of the ignition device, for example on the basis of a voltage signal and/or current signal, and the time range or crankshaft angle range to be examined can thus be determined

Step 2 of the method of FIG. 4 can likewise be carried out identically with step 2 of the method of FIG. 3.

In a step 3, high-pass or low-pass filtering is carried out. Changes to the observed electrical variable that occur with frequencies in the acoustic range and are characteristic for knocking combustion are to be filtered out as a useful signal portion by means of this filtering process. For example, filtering that lets pass a range from 4 kHz to 20 kHz is advantageous.

In a step 4, an extremum is then sought. Should an extremum be found, an integral is calculated in step 5 in a predefined range around the extremum. The integral limits can be calculated for example by addition or subtraction of a predefined constant to/from the crankshaft angle at which the extremum occurs. For example, the value of the integral or the value of the extremum can then be used as knock parameters. In a step 6, knock parameters thus calculated can be corrected in accordance with the operating point of the engine, similarly to the knock parameters K1 and K2 calculated by means of the method according to FIG. 3.

While this invention has been described as having an exemplary design, the present invention may be further modified within the spirit and scope of this disclosure. This application is therefore intended to cover any variations, uses, or adaptations of the invention using its general principles.

What is claimed is:

1. A method for knock detection in an internal combustion engine in which a fuel/air mixture is ignited by means of a corona discharge, the method comprising:
exciting an electrical resonant circuit, in which an ignition electrode that is electrically insulated with respect to combustion chamber walls constitutes a capacitor together with the combustion chamber walls, to generate the corona discharge; and
measuring and evaluating the course of an electrical variable of the resonant circuit for knock detection wherein the course of the electrical variable is checked for a local extremum after the start of the fuel combustion.

2. The method according to claim 1 wherein the electrical variable is the resonance frequency of the resonant circuit, the impedance of the resonant circuit or the phase position between current and voltage.

3. The method according to claim 1 wherein, to check whether the course of the electrical variable has an extremum after the start of the fuel combustion, the method includes subjecting a measurement signal of the electrical variable to high-pass filtering and checking the filtered signal for the presence of an extremum.

4. The method according to claim 3 further comprising calculating an integral of the measurement signal in a predefined range around a found extreme value as a characteristic variable of the knock behaviour.

5. The method according to claim 3 wherein the high-pass filtering has a threshold value of at least one kilohertz.

6. The method according to claim 3 wherein the high-pass filtering has a threshold value of at least three kilohertz.

7. The method according to claim 1 wherein, to check whether the course of the electrical variable has an extremum after the start of the combustion process, the method includes establishing whether the course of the electrical variable has more than two local extrema from the formation of the corona discharge.

8. The method according to claim 7 further comprising calculating the difference between a local maximum and a local minimum that occur after the start of the combustion process as a characteristic variable of the knock behaviour.

9. The method according to claim 7 calculating a first time derivative of the signal course of the electrical variable and using an extremum of the derivative that occurs after the start of the combustion process as a characteristic variable of the knock behaviour.

10. The method according to claim 1 wherein the method includes checking whether the course of the electrical variable has a local extremum within a crankshaft angle interval of at least 20° beginning at the ignition of the corona discharge.

11. The method according to claim 1 wherein the start of the fuel combustion is detected at an extremum in the course of the electrical variable.

12. The method according to claim 1 wherein the electrical variable is the resonance frequency of the resonant circuit.

13. The method according to claim 1 wherein the electrical variable is the impedance of the resonant circuit.

14. The method according to claim 1 wherein the electrical variable is the phase position between current and voltage.
